(19) United States
(12) Patent Application Publication
(10) Pub. No.: US 2009/0206552 A1
(43) Pub. Date: Aug. 20, 2009

(54) SHAPE MEMORY (ALLOY) HERMETIC SEAL AND THREADED JOINT INCORPORATING SAME

(75) Inventors: VI NGUY, CALGARY (CA); CONSTANTIN POPILIAN, CALGARY (CA)

Correspondence Address: SCHLUMBERGER CANADA LIMITED, 9450 17TH AVE, EDMONTON, AB, T6N 1M9, CA

(73) Assignee: SCHLUMBERGER TECHNOLOGY CORP., SUGAR LAND, TX (US)

(21) Appl. No.: 12/344,790

(22) Filed: Dec. 29, 2008

(30) Foreign Application Priority Data
Feb. 14, 2008 (CA) 2621300

(51) Int. Cl. F16J 15/08

(52) U.S. Cl. 277/306; 277/627

(57) ABSTRACT

A hermetic seal includes a face seal ring having a first end sealing face and a second end sealing face, a first sealing profile in contact with the first end sealing face, and a second sealing profile in contact with the second end sealing face. The face seal ring comprises a shape memory material. A hermetically-sealed, threaded joint includes a pin sub defining a first sealing profile, a box sub defining a second sealing profile, and a face seal ring comprising a shape memory material. The pin sub is threadedly engaged with the box sub. The face seal ring has a first end sealing face in contact with the first sealing profile and a second end sealing face in contact with the second sealing profile. The face seal ring is disposed about the pin sub.

### BACKGROUND OF THE INVENTION

1. Field of the Invention

The present invention relates to hermetic seals and, in particular, to metal-to-metal, hermetic seals.

2. Description of Related Art

Conventional, hermetically-sealed, threaded connections typically employ either an elastomeric seal, such as an O-ring, specially designed threads, such as tapered or rounded threads, self-sealing threads, or metal-to-metal seals. Elastomeric seals are not suitable for use in high temperature environments, such as environments at temperatures greater than about 204° C., and often require redundant sealing systems. Specially designed threads are geometrically and dimensionally restrictive and, thus, costly to produce. Metal-to-metal seals are suitable for use in high temperature environments, but are costly to produce and often cannot be disassembled and then reassembled.

Some conventional sealing systems incorporate one or more heat-shrinkable rings that comprise shape memory alloys. Shape memory alloys are a unique class of metallic alloys that can recover apparent permanent mechanical strains when the alloys are heated above a certain temperature. Shape memory alloys have two stable, solid phases: a high temperature, higher strength phase known as austenite and a low temperature, lower strength phase known as martensite. Additionally, martensite can exist in one of two forms, “twinned” or “detwinned.”

If a mechanically deforming load is applied to the element made from the shape memory alloy while in the twinned martensite phase, i.e., at low temperature, the martensite becomes detwinned and the material remains deformed upon releasing the load. Subsequent heating of the element to a high temperature results in the reverse phase transformation, i.e., from martensite to austenite, and a recovery of the shape prior to the element being mechanically deformed.

Alternatively, if a mechanically deforming load is applied to the element while in the high temperature, austenitic phase and the element is subsequently cooled, the element retains the deformed geometry in the detwinned, martensitic phase. Reheating the element results in the reverse phase transformation, i.e., from martensite to austenite, and a recovery of the shape prior to the element being mechanically deformed.

A conventional, heat-shrinkable ring is installed in a martensitic condition with an expanded inside diameter that allows the ring to be positioned about a seal. Upon heating, the ring changes to the austenitic condition and the inside diameter contracts, applying a radially-inward, clamping force on the seal. The clamping force generated by the contracting ring swages or deforms one or more sealing members to form the seal.

Such heat-shrinkable rings, however, are difficult to remove after the rings have been transformed into the austenitic state. A ring may be removed by cutting the ring using an abrasive or carbide cutting tool. Because shape memory alloys include titanium, the ring is difficult to cut and cutting the ring induces severe wear to the cutting tool. Alternatively, in some implementations, the ring may be removed by cooling the ring to below about −120° C. to contract the overall dimensions of the ring. Liquid nitrogen, which may be hazardous or impractical in many implementations, is typically used to cool such rings for removal.

There are many designs of hermetic seals well known in the art, however, considerable shortcomings remain.

### BRIEF SUMMARY OF THE INVENTION

In one aspect, a hermetic seal is provided. The hermetic seal includes a face seal ring having a first end sealing face and a second end sealing face, a first sealing profile in contact with the first end sealing face, and a second sealing profile in contact with the second end sealing face. The face seal ring comprises a shape memory material.

In another aspect, a hermetically-sealed, threaded joint is provided. The hermetically-sealed, threaded joint includes a box sub defining a first sealing profile, a pin sub defining a second sealing profile, and a face seal ring comprising a shape memory material. The pin sub is threadedly engaged with the box sub. The face seal ring has a first end sealing face in contact with the first sealing profile and a second end sealing face in contact with the second sealing profile. The face seal ring is disposed about the pin sub.

In yet another aspect, a method is provided. The method includes providing a face seal ring exhibiting a width that is less than a predetermined sealing width, the face seal ring comprising a shape memory material that has been trained to exhibit the predetermined sealing width after phase transformation from a martensitic state to an austenitic state. The method further includes placing the face seal ring about a pin sub and threadedly engaging threaded portions of the pin sub and a box sub until a sealing profile of the box sub is in contact with a first end sealing face of the face seal ring, a sealing profile of the pin sub is in contact with a second end sealing face of the face seal ring, and a desired torque value is reached. The method further includes heating the face seal ring to a temperature above an austenite transformation temperature, such that the face seal ring is transformed from the martensitic state to the austenitic state to form a hermetically-sealed, threaded joint.

The present invention provides significant advantages, including, but not limited to: (1) providing a hermetically sealed, threaded joint that is easy to assemble and disassemble; (2) providing a hermetic seal that has simple geometry; (3) providing a hermetic seal having components that are easy and cost effective to manufacture; (4) providing a hermetic seal having components that do not require tight manufacturing tolerances; and (5) providing a metal-to-metal, hermetic seal that is easily disassembled.

Additional objectives, features and advantages will be apparent in the written description which follows.

### BRIEF DESCRIPTION OF THE DRAWINGS

The novel features of the invention are set forth in the appended claims. However, the invention itself, as well as a preferred mode of use, and further objectives and advantages thereof, will best be understood by reference to the following detailed description when read in conjunction with the accompanying drawings, in which the leftmost significant digit(s) in the reference numerals denote(s) the first figure in which the respective reference numerals appear, wherein:

FIG. 1 is a side, elevational view of an illustrative embodiment of a hermetically-sealed, threaded joint;

FIG. 2 is a cross-sectional view of the hermetically-sealed, threaded joint of FIG. 1, taken along the line 2-2 in FIG. 1;

FIG. 3 is a cross-sectional view of an illustrative embodiment of a face seal ring of the joint of FIG. 1 in an austenitic state, the cross-sectional view corresponding to the view of FIG. 2;

FIG. 4 is a cross-sectional view of the face seal ring of FIG. 1 in a martensitic state, the cross-sectional view corresponding to the view of FIG. 2;

FIGS. 5 and 6 are flowcharts depicting illustrative embodiments of a method of preparing the face seal ring of FIGS. 2-4;

FIG. 7 is a flowchart depicting an illustrative embodiment of a method for installing the face seal ring of FIGS. 2-4 to form a hermetic seal of the threaded joint of FIG. 1; and

FIGS. 8-10 are enlarged views of a portion of FIG. 2, depicting the method of FIG. 7.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the scope of the invention as defined by the appended claims.

### DETAILED DESCRIPTION OF THE INVENTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

The present invention relates to a metal-to-metal hermetic seal that incorporates a face seal ring comprising a shape memory alloy. Rather than applying a clamping force to sealing members to produce the seal, the face seal ring provides a metal-to-metal seal along the end faces of the face seal ring between sealing profiles of adjacent members.

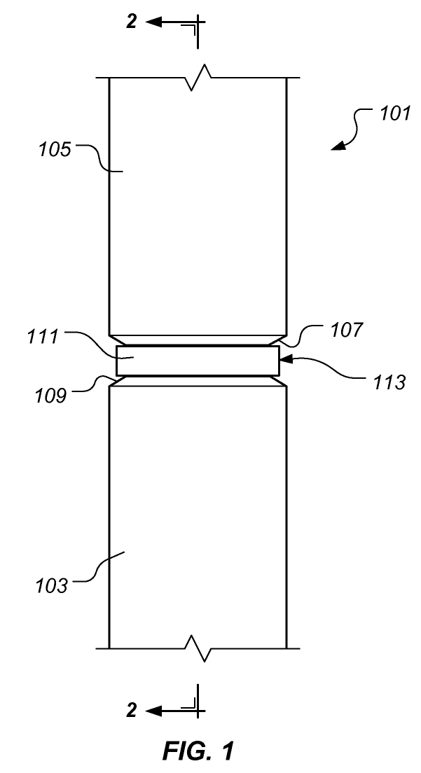

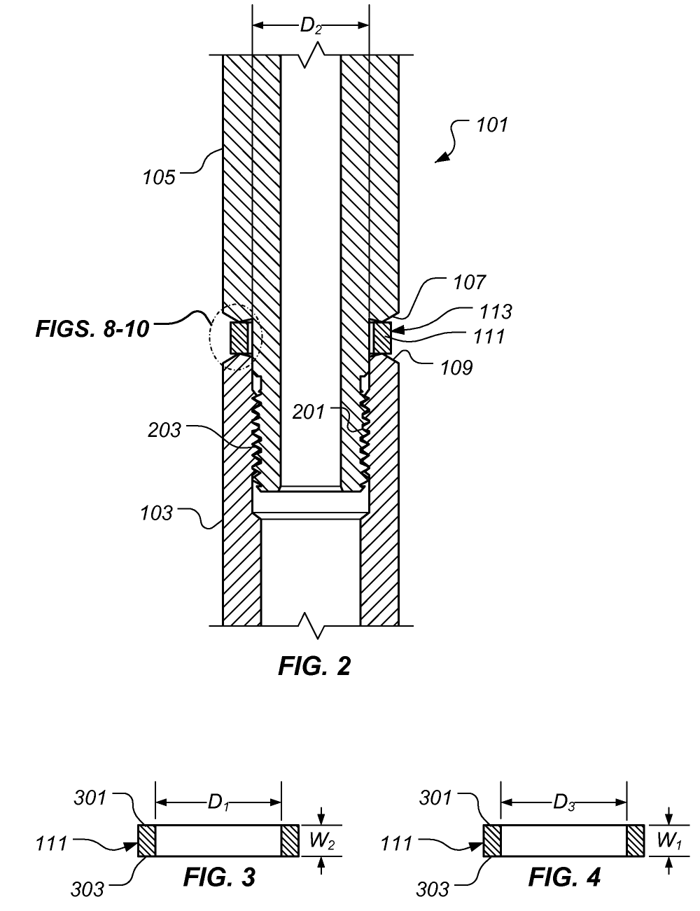

FIG. 1 is a side, elevational, view of a hermetically-sealed, threaded joint 101. FIG. 2 is a cross-sectional view of joint 101 taken along the line 2-2 in FIG. 1. In the illustrated embodiment, joint 101 comprises a box or female thread sub 103 and a pin or male thread sub 105. Box sub 103 and pin sub 105 comprise one or more metallic materials. As best shown in FIG. 2, box sub 103 comprises a threaded portion 201 and pin sub 105 comprises a threaded portion 203. Pin sub 105 extends into box sub 103. Threaded portion 201 of box sub 103 is threadedly engaged with threaded portion 203 of pin sub 105 to, among other things, mechanically join box sub 103 and pin sub 105. In one embodiment, the threaded connection between threaded portions 201 and 203 is a non-liquid tight connection.

Pin sub 105 further comprises a sealing profile 107 and box sub 103 further comprises a sealing profile 109. It should be noted that the particular geometric configurations of sealing profiles 107 and 109 are merely exemplary, as the present invention contemplates many geometric configurations of sealing profiles 107 and 109. A face seal ring 111 is disposed about pin sub 105 and, as best shown in FIG. 2, face seal ring 111 defines an inside diameter D₁ (labeled only in FIG. 3) that is larger than an outside diameter D₂ of pin sub 105, thus allowing face seal ring 111 to freely move about pin sub 105. Face seal ring 111 comprises a shape memory alloy, as is discussed in greater detail herein. Face seal ring 111 defines a first end sealing face 301 and a second end sealing face 303 (see FIG. 3). When threaded joint 101 is in a sealed configuration, face seal ring 111 is disposed between sealing profile 107 of pin sub 105 and sealing profile 109 of box sub 103 such that sealing profile 107 is in sealing contact with first end sealing face 301 of face seal ring 111 and sealing profile 109 is in sealing contact with second end sealing face 303. The interfaces between sealing profile 107 and first end sealing face 301 of face seal ring 111 and between sealing profile 109 and second end sealing face 303 of face seal ring 111 provide a hermetic seal to threaded joint 101, inhibiting fluids from passing between the outside of threaded joint 101 and the inside of threaded joint 101. Thus, a hermetic seal 113 comprises sealing profile 107 in sealing contact with first end sealing face 301 of face seal ring 111 and sealing profile 109 in sealing contact with second end sealing face 303 of face seal ring 111.

As noted above, face seal ring 111 comprises a shape memory alloy. Preferably, face seal ring 111 comprises a nickel/titanium shape memory alloy, also known as a Nitinol alloy. Referring to FIG. 4, face seal ring 111 exhibits a width W₁ when in the martensitic state that is less than a width W₂ (shown in FIG. 3) when face seal ring 111 is in the austenitic state after heating. Face seal ring 111 may exhibit a different inside diameter D₁ when in the austenitic state than an inside diameter D₃ that is exhibited when in the martensitic state. It should be noted, however, that the inside diameter, e.g., diameters D₁ or D₃, of face seal ring 111 has no substantive effect on the sealing ability of hermetic seal 113.

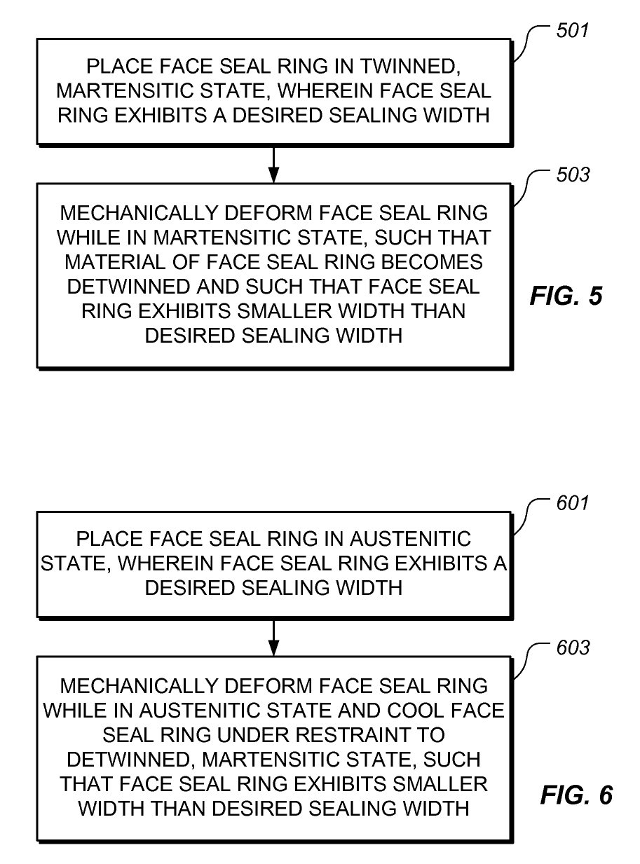

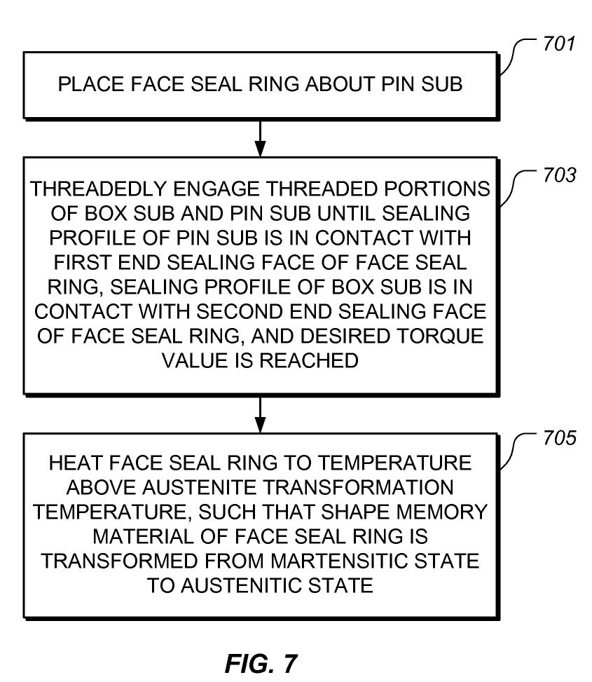

Prior to use, face seal ring 111 is “trained” using one of two methods. In a first method, depicted in FIG. 5, face seal ring 111 is placed in the twinned, martensitic state, wherein face seal ring 111 exhibits a desired sealing width, e.g., width W₂ shown in FIG. 3 (block 501). Face seal ring 111 is mechanically deformed while in the martensitic state, such that the material of face seal ring 111 becomes detwinned and such that face seal ring 111 exhibits a smaller width than the desired sealing width, e.g., width W₁ shown in FIG. 4 (block 503). Face seal ring 111 is now ready for use, as is described herein in relation to FIGS. 7-10.

Alternatively, in a second method, depicted in FIG. 6, face seal ring 111 is placed in the austenitic state, wherein face seal ring 111 exhibits a desired sealing width, e.g., width W₂ shown in FIG. 3 (block 601). Face seal ring 111 is mechanically deformed while in the austenitic state and face seal ring 111 is cooled under restraint to the detwinned, martensitic state, such that face seal ring 111 exhibits a smaller width than the desired sealing width, e.g., width W₁ shown in FIG. 4 (block 603). Face seal ring 111 is now ready for use, as described herein in relation to FIGS. 7-10.

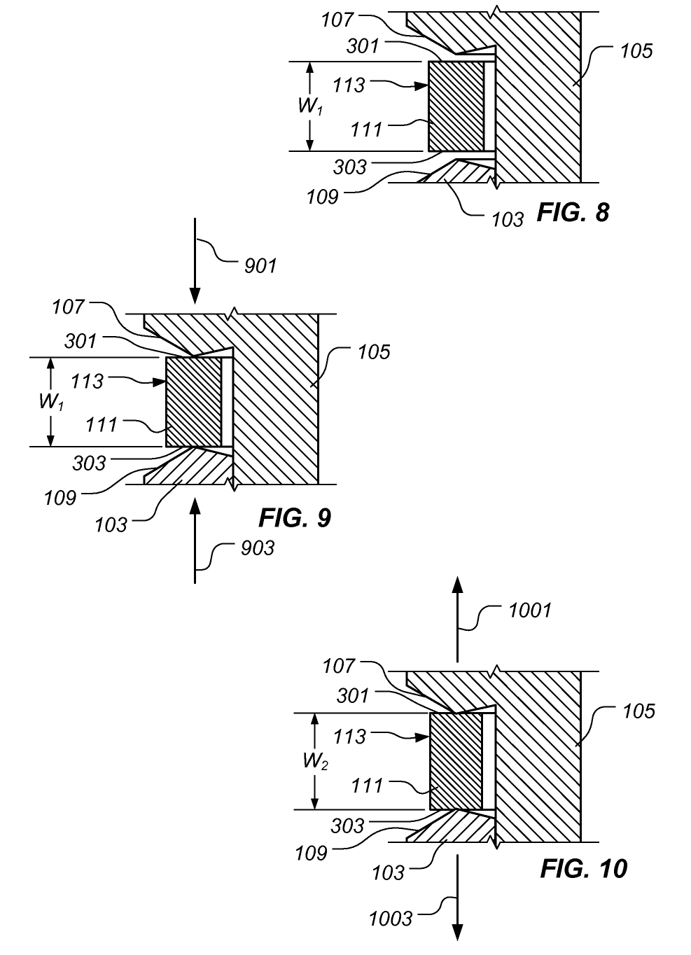

FIGS. 7-10 depict one particular method of installing and using hermetic seal 113, such as in threaded joint 101. FIG. 7 depicts the method as a flowchart, while FIGS. 8-10 depict the method by illustrating a portion of threaded joint 101, represented in FIG. 2. Referring now to FIG. 7, face seal ring 111 is placed about pin sub 105 (block 701) and threaded portions 201 and 203 of box sub 103 and pin sub 105 (shown in FIG. 2), respectively, are threadedly engaged until sealing profile 107 of pin sub 105 is in contact with first end sealing face 301 of face seal ring 111, sealing profile 109 of box sub 103 is in contact with second end sealing face 303 of face seal ring 111, and a desired torque value is reached (block 703). It should be noted that the desired torque value is implementation specific and, thus, the present invention contemplates many different desired torque values. FIG. 8 depicts the configuration of hermetic seal 113 prior to sealing profiles 107 and 109 coming into contact with sealing faces 301 and 303 of face seal ring 111. FIG. 9 depicts the configuration of hermetic seal 113 after the performance of block 703 of FIG. 7. Note that in the configuration depicted in FIG. 9, face seal ring 111 exhibits a width W₁ that is smaller than the desired sealing width, e.g., W₂. Execution of block 703 of FIG. 7 imparts forces, represented as arrows 901 and 903 in FIG. 9, on face seal ring 111, thus compressing face seal ring 111.

Still referring to FIG. 7, face seal ring 111 is heated to a temperature above the austenite transformation temperature, such that the shape memory material of face seal ring 111 is transformed from the martensitic state to the austenitic state (block 705). FIG. 10 depicts the configuration of hermetic seal 113 after the performance of block 705 of FIG. 7. During the performance of block 705, the width of face seal ring 111 changes from the smaller width W₁ to the desired sealing width W₂ while constrained by sealing profiles 107 and 109 of pin sub 105 and box sub 103, respectively. Face seal ring 111 increases in width, i.e., from width W₁ to width W₂, however, the spatial relationship between sealing profiles 107 and 109 is substantially unchanged. It should be noted that the difference between widths W₁ and W₂ is greater than merely the difference in dimension due to thermal expansion. Rather, the difference between widths W₁ and W₂ is due to the phase change between the martensitic state and the austenitic state. Face seal ring 111 in the austenitic state imparts forces on sealing profiles 107 and 109, represented by arrows 1001 and 1003. FIG. 10 depicts hermetic seal 113 in its operational configuration.

It should be noted that box sub 103 and pin sub 105 may be unthreaded from one another to disassemble threaded joint 101. Face seal ring 111 may then be easily removed from pin sub 105.

While hermetic seal 113 is depicted in the drawings and described herein as being used in joint 101, the scope of the present invention is not so limited. Rather, hermetic seal 113 may be employed in any threaded connection wherein a hermetic seal is desired. Moreover, sealing surfaces, such as sealing profiles 107 and 109 of pin sub 105 and box sub 103 and end sealing faces 301 and 303 of face seal ring 111 may be hardened via a heat treating process or by applying one or more coatings.

Hermetic seal 113, and thus threaded joint 101 and other joints incorporating hermetic seal 113, is particularly well suited for operation at temperatures above about 204° C., as metal-to-metal sealing contact is maintained between end sealing faces 301 and 303 of face seal ring 111 and sealing profiles 107 and 109 of pin sub 105 and box sub 103, respectively, at such temperatures. Moreover, in certain embodiments, hermetic seal 113 maintains metal-to-metal sealing in threaded joint 101 or other such joints at temperatures within a range of about −65° C. to about 300° C., as face seal ring 111 remains in the austenitic state within this temperature range.

Hermetic seal 113, and thus threaded joint 101 and other joints incorporating hermetic seal 113, are particularly well suited for incorporation into well completion equipment, artificial lift equipment, well drilling equipment, wireline equipment, well stimulation equipment, and the like.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the invention. Accordingly, the protection sought herein is as set forth in the claims below. Although the present invention is shown in a limited number of forms, it is not limited to just these forms, but is amenable to various changes and modifications.

What is claimed is:

1. A hermetic seal, comprising:
a face seal ring having a first end sealing face and a second end sealing face, the face seal ring comprising a shape memory material;
a first sealing profile in contact with the first end sealing face; and
a second sealing profile in contact with the second end sealing face.

2. The hermetic seal, according to claim 1, wherein the face seal ring imparts a force on the first sealing profile and the second sealing profile as a result of a phase transformation of the face seal ring from a martensitic state to an austenitic state.

3. The hermetic seal, according to claim 2, wherein the face seal ring remains in the austenitic state within a temperature range of about −65° C. to about 300° C.

4. The hermetic seal, according to claim 1, wherein the shape memory material is a nickel/titanium alloy.

5. The hermetic seal, according to claim 1, wherein the face seal ring remains in sealing contact with the first sealing profile and the second sealing profile within a temperature range of about −65° C. to about 300° C.

6. The hermetic seal, according to claim 1, wherein the face seal ring remains in sealing contact with the first sealing profile and the second sealing profile at temperatures above about 204° C.

7. The hermetic seal, according to claim 1, wherein the hermetic seal forms a portion of one of well completion equipment, artificial lift equipment, well drilling equipment wireline equipment, and well stimulation equipment.

8. A hermetically-sealed, threaded joint, comprising:
a pin sub defining a first sealing profile;
a box sub defining a second sealing profile, the pin sub being threadedly engaged with the box sub; and
a face seal ring comprising a shape memory material and having a first end sealing face in contact with the first sealing profile and a second end sealing face in contact with the second sealing profile, the face seal ring being disposed about the pin sub.

9. The hermetically-sealed, threaded joint according to claim 8, wherein the face seal ring imparts forces on the first sealing profile and the second sealing profile as a result of a phase transformation of the face seal ring from a martensitic state to an austenitic state.

10. The hermetically-sealed, threaded joint according to claim 9, wherein the face seal ring remains in the austenitic state within a temperature range of about −65° C. to about 300° C.

11. The hermetically-sealed, threaded joint according to claim 8, wherein the threaded engagement of the pin sub and the box sub forms a non-liquid tight connection.

12. The hermetically-sealed, threaded joint, according to claim 8, wherein the first sealing profile imparts a force to the first end sealing face of the face seal ring and the second sealing profile imparts a force to the second end sealing face of the face seal ring as a result of the pin sub being threadedly engaged with the box sub.

13. The hermetically-sealed, threaded joint according to claim 8, wherein an interface between the first sealing profile and the first end sealing face and an interface between the second sealing profile and the second end sealing face form a hermetic seal.

14. The hermetically-sealed, threaded joint according to claim 8, wherein the shape memory material is a nickel/titanium alloy.

15. The hermetically-sealed, threaded joint according to claim 8, wherein the face seal ring remains in sealing contact with the first sealing profile and the second sealing profile within a temperature range of about −65° C. to about 300° C.

16. The hermetically-sealed, threaded joint according to claim 8, wherein the face seal ring remains in sealing contact with the first sealing profile and the second sealing profile at temperatures above about 204° C.

17. The hermetically-sealed, threaded joint according to claim 8, wherein the hermetic seal forms a portion of one of well completion equipment, artificial lift equipment, well drilling equipment, wireline equipment, and well stimulation equipment.

18. A method, comprising:
providing a face seal ring exhibiting a width that is less than a predetermined sealing width, the face seal ring comprising a shape memory material that has been trained to exhibit the predetermined sealing width after phase transformation from a martensitic state to an austenitic state;
placing the face seal ring about a pin sub;
threadedly engaging threaded portions of the pin sub and a box sub until a sealing profile of the pin sub is in contact with a first end sealing face of the face seal ring, a sealing profile of the box sub is in contact with a second end sealing face of the face seal ring, and a desired torque value is reached; and
heating the face seal ring to a temperature above an austenite transformation temperature, such that the face seal ring is transformed from the martensitic state to the austenitic state to form a hermetically-sealed, threaded joint.

19. The method, according to claim 18, further comprising:
threadedly disengaging the threaded portions of the pin sub and the box sub after heating the face seal ring.

20. The method, according to claim 18, further comprising:
using the hermetically-sealed, threaded joint at a temperature within a range of about −65° C. to about 300° C.

21. The method, according to claim 18, further comprising:
using the hermetically-sealed, threaded joint at a temperature above about 204° C.
